(19) United States
(12) Patent Application Publication
(10) Pub. No.: US 2025/0119755 A1
(43) Pub. Date: Apr. 10, 2025

(54) SENSING AND COMMUNICATION METHOD AND APPARATUS, AND COMMUNICATION DEVICE

(71) Applicant: GUANGDONG OPPO MOBILE TELECOMMUNICATIONS CORP., LTD., Dongguan (CN)

(72) Inventors: Yanan LIN, Dongguan (CN); Jing XU, Dongguan (CN); Yi ZHANG, Dongguan (CN); Bin LIANG, Dongguan (CN)

(21) Appl. No.: 18/986,609

(22) Filed: Dec. 18, 2024

Related U.S. Application Data
(63) Continuation of application No. PCT/CN2022/106458, filed on Jul. 19, 2022.

(51) Int. Cl. H04W 16/14

(52) U.S. Cl. CPC H04W 16/14

(57) ABSTRACT

A method and apparatus for sensing and communication, a chip and a storage medium are provided. The method includes that: a first node receives first information from a second node. Herein, the first information includes at least one of: information of the second node, information of a sensed object, constraint information of a sensing node, constraint information of a sensing signal, constraint information of a sensing signal transmission resource, or information of a sensing service.

### CROSS-REFERENCE TO RELATED APPLICATION(S)

This application is a continuation of International Application No. PCT/CN2022/106458 filed on Jul. 19, 2022, the contents of which are hereby incorporated by reference in its entirety.

### BACKGROUND

Wireless communication and sensing are two important applications of a modern radio frequency technology. Traditionally, sensing and wireless communication exist separately, and such separate designs result in a waste of wireless spectra and hardware resources. Therefore, an integrated sensing and communication technology is proposed. The integrated sensing and communication technology integrates functions of wireless communication and sensing, enabling future wireless communication systems to have a sensing capability and providing a foundation for the future development of smart transportation, smart cities, smart factories, unmanned aerial vehicles and other services.

As an important node in the sensing and communication system, a sensing control node is configured to control and manage an entire sensing service. How to improve efficiency of control and management of the sensing control node needs to be optimized.

### SUMMARY

Embodiments of the disclosure relates to the field of mobile communication technologies, and provide a method and apparatus for sensing and communication.

In a first aspect, a method for sensing and communication provided in an embodiment of the disclosure includes the following operations.

A first node receives first information from a second node. The first information includes at least one of: information of the second node, information of a sensed object, constraint information of a sensing node, constraint information of a sensing signal, constraint information of a sensing signal transmission resource, or information of a sensing service.

In a second aspect, a method for sensing and communication provided in an embodiment of the disclosure includes the following operations.

A second node transmits first information to a first node. The first information includes at least one of: information of the second node, information of a sensed object, constraint information of a sensing node, constraint information of a sensing signal, constraint information of a sensing signal transmission resource, or information of a sensing service.

In a third aspect, an apparatus for sensing and communication provided in an embodiment of the disclosure is applied to a first node and includes a transceiver, a processor and a memory.

The memory is configured to store a computer program that, when executed by the processor, causes the processor to receive first information from a second node through the transceiver. The first information includes at least one of: information of the second node, information of a sensed object, constraint information of a sensing node, constraint information of a sensing signal, constraint information of a sensing signal transmission resource, or information of a sensing service.

In a fourth aspect, an apparatus for sensing and communication provided in an embodiment of the disclosure is applied to a second node and includes a transceiver, a processor and a memory.

The memory is configured to store a computer program that, when executed by the processor, causes the processor to transmit first information to a first node through the transceiver. The first information includes at least one of: information of the second node, information of a sensed object, constraint information of a sensing node, constraint information of a sensing signal, constraint information of a sensing signal transmission resource, or information of a sensing service.

### BRIEF DESCRIPTION OF THE DRAWINGS

The accompanying drawings, which are illustrated herein, provide a further understanding of the disclosure and constitute a part of this disclosure. The exemplary embodiments of the disclosure and their description are used to explain the disclosure and not to unduly limit the disclosure. In the drawings:

FIG. 1 is a schematic diagram of multiple sensing modes.

FIG. 2 is a schematic diagram of multiple sensing nodes participating in sensing.

FIG. 3 is a schematic flowchart of a method for sensing and communication provided in an embodiment of the disclosure.

FIG. 4 is a first schematic diagram of structure composition of an apparatus for sensing and communication provided in an embodiment of the disclosure.

FIG. 5 is a second schematic diagram of structure composition of an apparatus for sensing and communication provided in an embodiment of the disclosure.

FIG. 6 is a schematic structural diagram of a communication device provided in an embodiment of the disclosure.

FIG. 7 is a schematic structural diagram of a chip according to an embodiment of the disclosure.

FIG. 8 is a schematic block diagram of a communication system provided in an embodiment of the disclosure.

### DETAILED DESCRIPTION

For convenience of understanding of the technical solution of the embodiments of the disclosure, related technologies in the embodiments of the disclosure are described. The following related technologies may be used as alternative solutions and may be combined with the technical solution of the embodiments of the disclosure in various ways, and the solutions obtained by the combinations belong to the scope of protection of the embodiments of the disclosure.

The next-generation network (such as the sixth generation (6G) network) is expected to be a convergence of a mobile communication network, a sensing network and a computing power network. In a narrow sense, the sensing network refers to a system with capabilities of target positioning (ranging, speed measurement, angle measurement), target imaging, target detection, target tracking and target recognition. In a broad sense, the sensing network refers to a system with attributes and states of all services, networks, users and terminals, as well as environmental objects. For sensing applications, the sensing may include the following classifications.

Outdoor/wide-area/local-area applications, including a smart city (such as weather monitoring), smart transportation/a high-speed rail (such as high-precision map construction, road supervision, intrusion detection), a low-altitude application (such as unmanned aerial vehicles monitoring and obstacle avoidance, flight intrusion detection, and flight path management), and/or the like.

Indoor/local-area applications: including smart home and health management (such as respiratory monitoring, intrusion detection, gesture/pose recognition, motion monitoring, movement trajectory tracking), a smart factory (such as intrusion detection, material detection, item defect detection), and/or the like.

It should be noted that the above description is merely exemplary, which provides some classifications of sensing applications, but the scope of sensing applications is not limited to the above examples.

The wireless communication and sensing are two important applications of the modern radio frequency technology. The sensing uses radio waves to detect parameters of a physical environment, to achieve environmental sensing such as target positioning, motion recognition, and imaging. Traditionally, the sensing is independent of the wireless communication, and there may be a waste of wireless spectra and hardware resources due to such separate design. After entering the beyond fifth generation (B5G) and 6G era, the communication spectrum may move towards millimeter wave, terahertz, and visible light communications. In the future, the spectrum of wireless communication may coincide with the traditional sensing spectrum. The integrated sensing and communication technology integrates the functions of wireless communication and sensing, and is able to: perform the sensing function by using the radio resources of wireless communication; perform the sensing service in a wider range by using a widely deployed cellular network; perform joint sensing by using a base station and multiple terminals to achieve a higher sensing accuracy; and perform the sensing function by reusing a hardware module of wireless communication to reduce the cost. In summary, the integrated sensing and communication technology enables the future wireless communication systems to have a sensing capability and provides a foundation for the future development of smart transportation, smart cities, smart factories, unmanned aerial vehicles and other services.

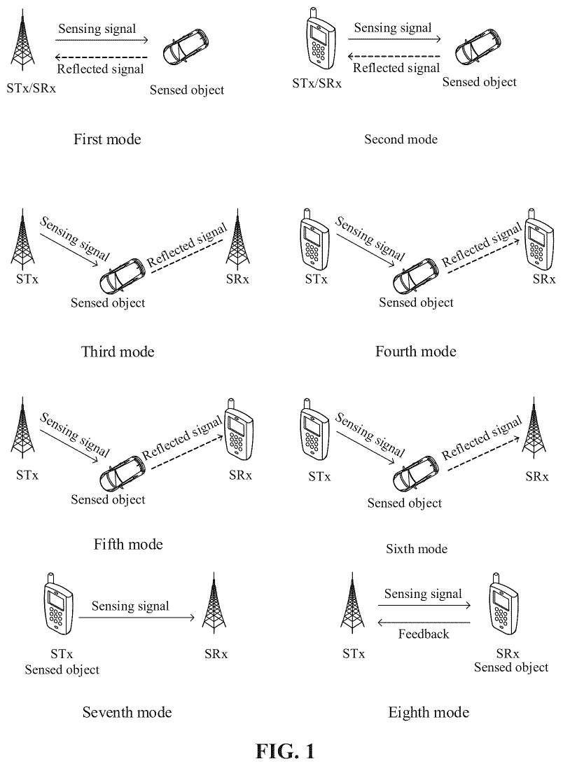

The sensing may be divided into eight sensing modes as illustrated in FIG. 1. A first mode is a sensing mode with self-transmitting and self-receiving by a base station. The base station serves as both a transmitting node (denoted as STx) and a receiving node (denoted as SRx) of a sensing signal. Specifically, the base station transmits a sensing signal to a sensed object and receives a sensing signal reflected by the sensed object (referred to as a reflected signal for short). A second mode is a sensing mode with self-transmitting and self-receiving by a terminal. The terminal serves as both a transmitting node (denoted as STx) and a receiving node (denoted as SRx) of a sensing signal. Specifically, the terminal transmits a sensing signal to a sensed object and receives a sensing signal reflected by the sensed object (referred to as a reflected signal for short). A third mode is a sensing mode with cooperation between base stations. A base station serves as a transmitting node (denoted as STx) of a sensing signal and another base station serves as a receiving node (denoted as SRx) of a sensing signal. Specifically, a base station transmits a sensing signal to a sensed object and another base station receives a sensing signal reflected by the sensed object (referred to as a reflected signal for short). A fourth mode is a sensing mode with cooperation between terminals. A terminal serves as a transmitting node (denoted as STx) of a sensing signal and another terminal serves as a receiving node (denoted as SRx) of a sensing signal. Specifically, a terminal transmits a sensing signal to a sensed object and another terminal receives a sensing signal reflected by the sensed object (referred to as a reflected signal for short). A fifth mode is a sensing mode with base station-terminal cooperation. A base station serves as a transmitting node (denoted as STx) of a sensing signal and a terminal serves as a receiving node (denoted as SRx) of a sensing signal. Specifically, the base station transmits a sensing signal to a sensed object and the terminal receives a sensing signal reflected by the sensed object (referred to as a reflected signal for short). A sixth mode is a sensing mode with terminal-base station cooperation. A terminal serves as a transmitting node (denoted as STx) and a base station (denoted as SRx) serves as a receiving node of a sensing signal. Specifically, the terminal transmits a sensing signal to a sensed object and the base station receives a sensing signal reflected by the sensed object (referred to as a reflected signal for short). A seventh mode is a sensing mode with a sensed object serving as a sensing signal transmitting node. Specifically, the sensed object serves as a transmitting node (denoted to as STx) of a sensing signal to transmit the sensing signal, and a receiving node (denoted to as SRx) of the sensing signal receives the sensing signal. An eight mode is a sensing mode with a sensed object serving as a sensing signal receiving node. Specifically, a transmitting node (denoted as STx) of a sensing signal transmits the sensing signal to the sensed object, and the sensed object serves as a receiving node (denoted to as SRx) of the sensing signal to receive the sensing signal and perform feedback to the transmitting node of the sensing signal.

It should be noted that the transmitting node of the sensing signal and the receiving node of the sensing signal are functionally distinguished, however, a physical node may serve as only the transmitting node of the sensing signal, or serve as only the receiving node of the sensing signal, or serve as both the transmitting node and the receiving node of the sensing signal. For convenience of description, the transmitting node of the sensing signal and the receiving node of the sensing signal are collectively referred to as sensing nodes. The sensing node is a node that transmits and/or receives the sensing signal, such as a base station, a mobile phone, an Internet of things (IoT) device, or the like.

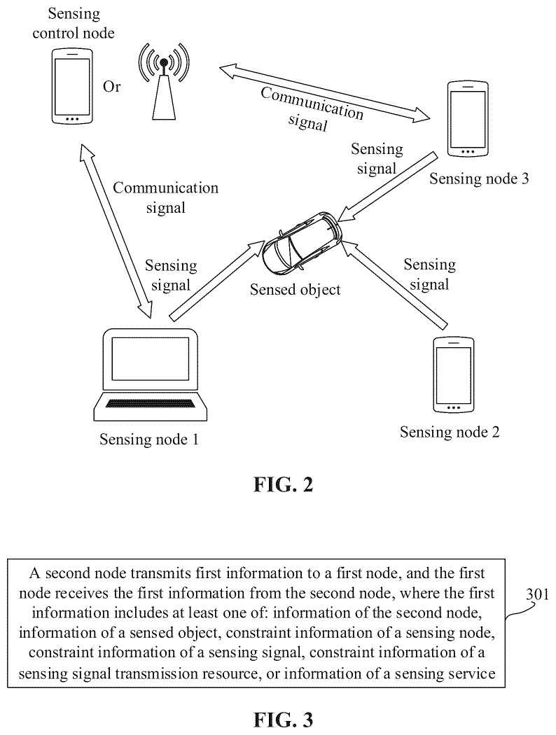

In the above eight sensing modes, there is only a single or a pair of sensing nodes. When there are multiple sensing nodes around a sensed object, the multiple sensing nodes participating in sensing together can improve the accuracy of sensing, such that requirements of more complex sensing services can be satisfied and richer sensing services can be provided. When there are multiple sensing nodes in a system, there may be a sensing control node to control and manage the entire sensing service, thereby improving the sensing efficiency. The sensing control node may be a base station, a terminal, or a core network element. An example of multiple sensing nodes participating in sensing is illustrated in FIG. 2. In the example illustrated in FIG. 2, a sensing control node is a terminal or a base station, and a sensing node 1, a sensing node 2, and a sensing node 3 are around a sensed object. Communication signals may be transmitted between the sensing control node and the multiple sensing nodes, and sensing signals may be transmitted between the sensing nodes and the sensed object. It can be understood that the function of the communication signal is for communication, and the function of the sensing signal is for sensing.

As an important node in the sensing and communication system, a sensing control node is configured to control and manage the entire sensing service. How to improve efficiency of control and management of the sensing control node needs to be optimized. Therefore, solutions of embodiments of the disclosure are provided as follows.

It is noted that the term “and/or” in the disclosure is only an association relationship for describing associated objects, and represents that three relationships may exist. For example, A and/or B may represent the following three cases: A exists separately, both A and B exist, and B exists separately. In addition, the character “/” in the disclosure generally indicates an “or” relationship between the associated objects. It should also be understood that the word “indication” mentioned in embodiments of the disclosure may be a direct indication or an indirect indication, or may be indicative of an association relationship. For example, A indicates B, which may represent that A directly indicates B, for example, B may be obtained through A; or that A indirectly indicates B, for example, A indicates C, and B may be obtained through C; or that there is an association between A and B. It should also be understood that the word “correspondence” in embodiments of the present disclosure may represent that the associated objects have a direct or indirect correspondence relationship, or an association relationship, or a relationship of indicating and being indicated, configured and being configured, or the like.

It should be noted that the term “sensing” used herein may be replaced with another name, and any name that can represent a meaning related to the sensing may be used, such as positioning, ranging, speed measurement, angle measurement, target imaging, target detection, target tracking, target recognition, and/or the like.

For convenience of understanding the technical solutions of the embodiments of the disclosure, the technical solutions in the disclosure are described below through detailed embodiments. The above related technologies used as alternative solutions may be combined with the technical solution of the embodiments of the disclosure in various ways, and the solutions obtained by the combinations belong to the scope of protection of the embodiments of the disclosure. The embodiments of the disclosure include at least part of the following contents.

In a sensing process, a sensing signal transmitting node transmits a sensing signal, and a sensing signal receiving node receives a sensing signal. On the one hand, the sensing signal transmitting node and the sensing signal receiving node may be the same node (such as in the first mode and the second mode in FIG. 1). The sensing signal transmitting node and the sensing signal receiving node may also be different nodes (such as in the third mode, the fourth mode, the fifth mode, the sixth mode, the seventh mode and the eighth mode in FIG. 1). On the other hand, the sensed object may not participate in receiving and/or transmitting of the sensing signal, and may only refract or reflect the sensing signal (such as in the first mode, the second mode, the third mode, the fourth mode, the fifth mode and the sixth mode in FIG. 1). The sensed object may also participate in the receiving and/or transmitting of the sensing signal, that is, the sensed object may serve as the sensing signal transmitting node or the sensing signal receiving node (such as in the seventh mode and the eighth mode in FIG. 1). After receiving the sensing signal, the sensing signal receiving node obtains a corresponding signal characteristic quantity based on the received sensing signal. The signal characteristic quantities obtained by multiple sensing signal receiving nodes are used for implementing sensing of the sensed object (such as positioning, ranging, speed measurement, angle measurement, target imaging, target detection, target tracking and target recognition, and/or the like).

In order to control and manage the sensing process of the sensing service, it is necessary to configure sensing by the sensing control node, for example, to configure at least one of: a sensing node, information related to a sensing signal, a measurement node, or information related to a measurement signal. Herein, the sensing node refers to a node that transmits and/or receives the sensing signal. The measurement node refers to a node that transmits and/or receives the measurement signal. A purpose of the sensing process corresponding to the sensing signal is to sense a sensed object, and the reference may be made to the description in the above paragraphs for the specific implementation of the sensing process. A purpose of the measurement process corresponding to the measurement signal is to enable the sensing control node to select an actually used sensing node from multiple nodes capable of performing sensing, and the specific implementation of the measurement process is roughly as follows. A measurement signal transmitting node transmits the measurement signal, and a measurement signal receiving node receives the measurement signal and sends a measurement result to the sensing control node, so that the sensing control node selects, based on the measurement result, an appropriate node as the sensing node to execute the sensing process subsequently. As an implementation, the measurement node may perform only the measurement process without the sensing process. As another implementation, the measurement node may perform both the measurement process and the sensing process.

In some embodiments, the information related to the sensing signal includes at least one of: a type of the sensing signal, a signal characteristic of the sensing signal (e.g., a sequence length), and a transmission resource for the sensing signal.

In some embodiments, the information related to the measurement signal includes at least one of: a type of the measurement signal, a signal characteristic of the measurement signal (e.g., a sequence length), or a transmission resource for the measurement signal.

As an implementation, the measurement signal and the sensing signal may be the same signal. As another implementation, the measurement signal and the sensing signal may be different signals.

How to effectively configure the sensing by the sensing control node depends on some auxiliary information, which will be illustrated with reference to FIG. 3 below.

FIG. 3 is a schematic flowchart of a method for sensing and communication provided in an embodiment of the disclosure. As illustrated in FIG. 3, the method for sensing and communication includes the following operation.

At operation 301, a second node transmits first information to a first node, and the first node receives the first information from the second node. The first information includes at least one of: information of the second node, information of a sensed object, constraint information of a sensing node, constraint information of a sensing signal, constraint information of a sensing signal transmission resource, or information of a sensing service.

According to the technical solution provided in the present disclosure, the first node can control and manage the entire sensing service efficiently based on the first information, thereby ensuring reliability of the sensing and communication.

In an embodiment of the present disclosure, the first node is a sensing control node. It should be noted that the description for the sensing control node may be replaced with other names, and any name that can represent the meanings associated with the sensing control node may be used for replacing, such as a sensing center node, a sensing management node, a sensing coordination node, or the like. In some implementations, the first node may be a base station, a terminal, or a core network element.

In an embodiment of the present disclosure, the second node is a node for initiating the sensing service; or, the second node is a node for transmitting a sensing service request.

As an implementation, the second node is the node for initiating the sensing service. In one case, the second node and the first node are the same node, and in this case, the first node receives the first information transmitted by itself, which may be understood as that the first node obtains the first information from itself. In another case, the second node and the first node are different nodes, and in this case, the first node receives the first information transmitted by the second node through a connection between the first node and the second node.

As another implementation, the second node is the node for transmitting the sensing service request, and the second node may serve as the node for initiating the sensing service to transmit the sensing service request, or the second node may transmit the sensing service request upon being triggered by a node for initiating the sensing service. The second node and the first node are different nodes. In one case, the second node transmits the sensing service request to the first node, where the sensing service request carries the first information. In another case, the second node transmits the sensing service request to a third node, and the third node forwards the sensing service request to the first node, where the sensing service request carries the first information. Alternatively, the second node transmits the sensing service request to a third node, the third node instructs the second node to transmit the first information to the first node. In some implementations, the third node may be a base station or a core network element.

In an embodiment of the present disclosure, after the first node obtains the first information, the first node may configure, based on the first information, at least one of: a sensing node, sensing signal-related information, a measurement node, or measurement signal-related information. Herein, for the meanings of the sensing node, the sensing signal-related information, the measurement node, and the measurement signal-related information, the references may be made to the sensing node, the information related to the measurement signal, the measurement node and the information related to the measurement signal in the foregoing description.

In some implementations, the first node transmits third information for configuring at least one of: a sensing node, sensing signal-related information, a measurement node, or measurement signal-related information. As an implementation, the first node transmits the third information upon generating the third information. Herein, the first node may transmit the third information to the sensing node and/or the measurement node configured by the first node. As another implementation, the first node, after generating the third information, transmits the third information based on control of a third node. Herein, the third node may control when the first node transmits the third information and/or to which node the third information is transmitted. In some implementations, the third node may be a base station or a core network element.

In an embodiment of the present disclosure, the first information includes at least one of: information of the second node, information of a sensed object, constraint information of a sensing node, constraint information of a sensing signal, constraint information of a sensing signal transmission resource, or information of a sensing service. The information will be described below.

### Information of the Second Node

In some implementations, the information of the second node includes at least one of: a type of the second node, battery level information of the second node, position information of the second node, radio resource occupancy information of the second node, sensing capability information of the second node, or measurement capability information of the second node.

In some implementations, the information of the second node is used for the first node to determine whether to configure the second node as the measurement node and/or the sensing node, and further used for the first node to configure the measurement signal-related information and/or the sensing signal-related information for the second node. In some implementations, the sensing signal-related information includes at least one of: a type of a sensing signal, a signal characteristic of the sensing signal (e.g., a sequence length), and a transmission resource for the sensing signal. The measurement signal-related information includes at least one of: a type of a measurement signal, a signal characteristic of the measurement signal (e.g., a sequence length), or a transmission resource for the measurement signal.

As an example, the first node determines, based on the type of the second node, whether to configure the second node as the measurement node and/or the sensing node. The first node determines, based on the battery level information of the second node, whether the battery level of the second node is enough to perform a measurement process and/or a sensing process, to determine whether to configure the second node as the measurement node and/or the sensing node. The first node determines, based on the position information of the second node, whether the second node is located in a specific area range, to determine whether to configure the second node as the measurement node and/or the sensing node. The first node configures, based on the radio resource occupancy information of the second node, the sensing signal-related information and/or the measurement signal-related information for the second node. The first node determines, based on the sensing capability information of the second node, whether to configure the second node as the sensing node and/or configure the sensing signal-related information for the second node. The first node determines, based on the measurement capability information of the second node, whether to configure the second node as the measurement node and/or configure the measurement signal-related information for the second node.

As an example, the type of the second node may be one of: a mobile phone, a watch, a vehicle, an IoT device, or the like.

As an example, the battery level information of the second node may be: remaining battery level information, a continuous power supply state, a power saving mode, a low power consumption state, and/or the like.

As an example, the position information of the second node may be obtained by a positioning module of the second node. The position information of the second node may also be obtained by a positioning method such as Wi-Fi positioning, base station positioning, triangulation positioning, or ranging positioning. The position information of the second node may also be manually calibrated. A position information accuracy of the position information of the second node is associated with a positioning method for the position information of the second node, and different positioning methods may correspond to different position information accuracies. The position information accuracy may be calibrated by a distance, such as a 10-meter positioning accuracy, a 2-meter positioning accuracy. The position information accuracy may also be calibrated by a level of positioning accuracy, such as a high positioning accuracy, a medium positioning accuracy, a low positioning accuracy.

As an example, the radio resource occupancy information of the second node may include at least one of: a type of a service received and/or transmitted by the second node, a data amount of the service received and/or transmitted by the second node, or a radio resource occupied by the service received and/or transmitted by the second node. Herein, the radio resource occupied by the service received and/or transmitted by the second node may be, for example, semi-statically configured, dynamically scheduled, or pre-configured, and the second node may determine the radio resource occupied by the service received and/or transmitted by the second node through configuration information.

In some implementations, the sensing capability information of the second node includes at least one of: first indication information for indicating whether the second node is able to serve as a sender of a sensing signal and/or a receiver of the sensing signal, second indication information for indicating a sensing signal characteristic quantity supported by the second node, or third indication information for indicating a sensing signal transmission resource supported by the second node.

As an example, the sensing signal characteristic quantity includes at least one of: a received signal strength indicator (RSSI) of the sensing signal, a reference signal receiving power (RSRP) of the sensing signal, a channel quality indicator (CQI) of the sensing signal, an angle of arrival of the sensing signal, beam information of the sensing signal, a line-of-sight path of the sensing signal, a multipath delay of the sensing signal, a Doppler shift of the sensing signal, a phase of the sensing signal, complete channel information of the sensing signal, or quantized channel information of the sensing signal. The sensing signal characteristic quantity supported by the second node may be understood as a characteristic quantity of the sensing signal that can be measured by the second node. The second node may determine, based on the capability of the second node itself, the sensing signal characteristic quantity supported by the second node.

As an example, the sensing signal transmission resource includes at least one of: a time domain resource for the sensing signal or a frequency domain resource for the sensing signal. The sensing signal transmission resource supported by the second node may be understood as the sensing signal transmission resource available to the second node. The second node may determine the sensing signal transmission resource available to the second node based on the radio resource occupancy information of the second node and/or sensing signal transmission resource(s) configured by a network.

In some implementations, the measurement capability information of the second node includes at least one of: fourth indication information for indicating whether the second node is able to serve as a sender of a measurement signal and/or a receiver of the measurement signal, fifth indication information for indicating a measurement signal characteristic quantity supported by the second node, sixth indication information for indicating a measurement accuracy supported by the second node, or seventh indication information for indicating a measurement signal transmission resource supported by the second node.

As an example, the measurement signal characteristic quantity includes at least one of: an RSSI of the measurement signal, an RSRP of the measurement signal, a CQI of the measurement signal, an angle of arrival of the measurement signal, beam information of the measurement signal, a line-of-sight path of the measurement signal, a multipath delay of the measurement signal, a Doppler shift of the measurement signal, a phase of the measurement signal, complete channel information of the measurement signal, or quantized channel information of the measurement signal. The measurement signal characteristic quantity supported by the second node may be understood as a characteristic quantity of the measurement signal that can be measured by the second node. The second node may determine, based on the capability of the second node itself, the measurement signal characteristic quantity supported by the second node.

As an example, the measurement signal transmission resource includes at least one of: a time domain resource for the measurement signal or a frequency domain resource for the measurement signal. The measurement signal transmission resource supported by the second node may be understood as the measurement signal transmission resource available to the second node. The second node may determine the measurement signal transmission resource available to the second node based on the radio resource occupancy information of the second node and/or measurement signal transmission resource(s) configured by the network.

In some implementations, the first node receives a measurement result corresponding to the measurement signal. The measurement result is used for the first node to configure at least one of: a sensing node, a sensing signal, or a sensing signal transmission resource.

### Information of the Sensed Object

In some implementations, the information of the sensed object includes at least one of: a relative position relationship between the sensed object and the second node, an appearance characteristic of the sensed object, or a movement characteristic of the sensed object.

In some implementations, the information of the sensed object is used for the first node to configure a sensing node.

As an example, the first node configures, based on the relative position relationship between the sensed object and the second node, a node with a distance relative to the sensed object less than or equal to a distance threshold as the sensing node. The first node configures, based on the appearance characteristic of the sensed object, a node capable of sensing the appearance characteristic of the sensed object as the sensing node. The first node configures, based on the movement characteristic of the sensed object, a node capable of sensing the movement characteristic of the sensed object as the sensing node.

In some implementations, the relative position relationship between the sensed object and the second node includes at least one of: at least one of a position, a distance, an angle, or a height of the sensed object relative to the second node, or a wearing state of the second node by the sensed object.

As an example, the second node is a vehicle, the sensed object is a passenger, and the passenger may be located at different positions in the vehicle (such as at a driver's seat, a passenger's seat, a rear seat). The relative position relationship between the sensed object and the second node is at least one of a position, a distance, an angle, or a height of the passenger relative to the vehicle.

As an example, the second node is a television and the sensed object is a person. The relative position relationship between the sensed object and the second node is at least one of a position, a distance, an angle, or a height of the person relative to the television.

As an example, the second node is a watch and the sensed object is a person wearing the watch. The relative position relationship between the sensed object and the second node is a wearing state of the watch by the person, for example, whether the watch is worn by the person, whether the watch is worn on the left hand or the right hand.

The second node may detect the relative position relationship between the sensed object and the second node by a sensor of the second node. The second node may also measure the relative position relationship between the sensed object and the second node by using a positioning method such as triangulation positioning or ranging positioning.

In some implementations, the appearance characteristic of the sensed object is used for determining at least one of: a type of the sensed object, or a size of the sensed object.

As an example, the type of the sensed object may be: an adult, a child, an animal, a vehicle, or the like.

As an example, the size of the sensed object may be: a height, a width, a length, or the like.

The second node may detect the appearance characteristic of the sensed object by a sensor of the second node.

In some implementations, the movement characteristic of the sensed object includes at least one of: a movement mode of the sensed object, a movement speed of the sensed object, a movement direction of the sensed object, or a movement range of the sensed object.

As an example, the movement mode of the sensed object may be: a horizontal movement, a vertical movement, a unidirectional movement, a reciprocating movement, a walking movement, a crawling movement, a movement accompanying a cargo-carrying device, or the like.

As an example, the movement speed of the sensed object may be: a linear velocity, an angular velocity, or the like.

As an example, the movement direction of the sensed object may be: a movement direction with respect to the earth, a movement direction with respect to a reference object, or the like.

As an example, the movement range of the sensed object may be: a range determined by a length and a width, a range determined by a circle center and a radius, or a range determined by other boundary information, or the like.

### Constraint Information of the Sensing Node

In some implementations, the constraint information of the sensing node includes at least one of: node information allowed to participate in sensing or node information restricted from participating in sensing. Herein, the node information allowed to participate in sensing includes: at least one node type allowed to participate in sensing and/or at least one node identifier allowed to participate in sensing. The node information restricted from participating in sensing includes at least one node type restricted from participating in sensing and/or at least one node identifier restricted from participating in sensing.

In some implementations, the constraint information of the sensing node is used for the first node to select a sensing node from within the restricted nodes.

As an example, the node type restricted from participating in sensing includes a mobile phone and an IoT device, and the first node selects a sensing node among other types of nodes other than the mobile phone and the IoT device. The node identifier allowed to participate in sensing includes identifier 1 and identifier 2, and the first node selects a sensing node from the nodes corresponding to identifier 1 and identifier 2.

### Constraint Information of the Sensing Signal

In some implementations, the constraint information of the sensing signal includes at least one of: signal information allowed to participate in sensing or signal information restricted from participating in sensing. Herein, the signal information allowed to participate in sensing includes: at least one signal type allowed to participate in sensing and/or at least one signal characteristic allowed to participate in sensing. The signal information restricted from participating in sensing includes at least one signal type restricted from participating in sensing and/or at least one signal characteristic restricted from participating in sensing.

In some implementations, the constraint information of the sensing signal is used for the first node to select a sensing signal from within the restricted signals.

### Constraint Information of the Sensing Signal Transmission Resource

In some implementations, the constraint information of the sensing signal transmission resource includes at least one of: a transmission resource allowed to participate in sensing or a transmission resource restricted from participating in sensing.

In some implementations, the constraint information of the sensing signal transmission resource is used for the first node to select a sensing signal transmission resource from within the restricted transmission resources.

### Information of the Sensing Service

In some implementations, the information of the sensing service includes at least one of: a type of the sensing service, a sensing characteristic corresponding to the sensing service, a sensing time range corresponding to the sensing service, a triggering condition of the sensing service, an interruption condition of the sensing service, or a restart condition of the sensing service.

In some implementations, the information of the sensing service is used for the first node to configure a sensing node and/or sensing signal-related information. In some implementations, the sensing signal-related information includes at least one of: a type of a sensing signal, a signal characteristic of the sensing signal (e.g., a sequence length), or a transmission resource for the sensing signal.

As an example, the type of the sensing service may be intrusion monitoring, health monitoring, breathing monitoring, fall monitoring, or the like. Different types of sensing services may have different requirements in the sensing process, such as different sensing signal characteristic quantities that need to be detected, different detection accuracies, different sensing latencies, and/or the like. The first node configures an appropriate sensing node and/or sensing signal-related information based on the type of the sensing service, so that the sensing process performed based on the configured sensing node and/or the sensing signal-related information meets the requirements corresponding to the sensing type.

In some implementations, the sensing characteristic corresponding to the sensing service includes at least one of: a sensing signal characteristic quantity corresponding to the sensing service, a detection accuracy corresponding to the sensing service, or a sensing latency corresponding to the sensing service.

As an example, the sensing signal characteristic quantity includes at least one of: an RSSI of the sensing signal, an RSRP of the sensing signal, a CQI of the sensing signal, an angle of arrival of the sensing signal, beam information of the sensing signal, a line-of-sight path of the sensing signal, a multipath delay of the sensing signal, a Doppler shift of the sensing signal, a phase of the sensing signal, complete channel information of the sensing signal, or quantized channel information of the sensing signal.

The first node configures an appropriate sensing node and/or sensing signal-related information based on the sensing characteristic of the sensing service, so that the sensing process performed based on the configured sensing node and/or the sensing signal-related information meets the sensing characteristic corresponding to the sensing service.

In some implementations, the sensing time range corresponding to the sensing service is represented by at least two of: a starting time corresponding to the sensing service, an ending time corresponding to the sensing service, or a duration corresponding to the sensing service. Alternatively, the sensing time range corresponding to the sensing service is represented by at least one of: an ending time corresponding to the sensing service, or a duration corresponding to the sensing service, where a starting time corresponding to the sensing service is a predefined reference time. Herein, alternatively, the reference time is a time at which the first node receives the first information from the second node.

As an example, the sensing time range corresponding to the sensing service is from eight o'clock to eighteen o'clock. The sensing time range corresponding to the sensing service starts from eight o'clock and lasts for ten hours. The sensing time range corresponding to the sensing service starts from a time of receiving the first information and lasts for ten hours.

In some implementations, the triggering condition of the sensing service includes: a sensing node obtains a trigger signaling for triggering the sensing service. Herein, alternatively, the trigger signaling is a physical layer signaling or a higher layer signaling.

In some implementations, the interruption condition of the sensing service includes at least one of: a sensed object and/or a sensing node generate a communication service other than the sensing service, a movement state (such as starting movement, stopping movement) of the sensed object changes, a position of the sensed object changes, the position of the sensed object is not in a target range, or consecutive multiple times of sensing failures occur for the sensing service.

Herein, alternatively, a condition for determining the sensing failures includes at least one of: no resource being used for transmission of the sensing signal, no sensing signal being detected, or a value of the sensing signal characteristic quantity not satisfying a first constraint condition or a value of the sensing signal characteristic quantity satisfying a second constraint condition. The first constraint condition or the second constraint condition is a condition of, for example, being lower than a first threshold or higher than a second threshold.

In some implementations, the restart condition of the sensing service includes: ending of a communication service, other than the sensing service, of a sensed object and/or a sensing node.

In an embodiment of the present disclosure, the first node may receive the first information actively transmitted by the second node. Alternatively, the first node transmits second information to the second node, and the second node receives the second information from the first node, where the second information is used for requesting the second node to report the first information to the first node; and then, the first node may receive the first information from the second node. In some embodiments, the second information is further used for indicating information type(s) in the first information reported by the second node. The second node reports the first information including the information type(s) to the first node based on the indication of the second information.

It should be noted that the core network element involved in the above-described embodiments of the present disclosure may be an existing core network element (whose function needs to be enhanced) or a newly added core network element. The existing core network element may be, for example, an access and mobility management function (AMF) network element.

Preferred embodiments of the disclosure have been described in detail with reference to the accompanying drawings, however, the disclosure is not limited to the specific details of the above embodiments. Various simple modifications may be made to the technical solution of the present disclosure within the scope of the technical conception of the disclosure, and these simple modifications all belong to the scope of protection of the present disclosure. For example, various specific technical features described in the above specific embodiments may be combined in any suitable manner without contradiction, and various possible combinations are not further described in the disclosure in order to avoid unnecessary repetition. For another example, various implementations of the disclosure may also be combined in any manner as long as the combination does not depart from the idea of the disclosure and it is also be considered as the contents disclosed in the disclosure. For another example, various embodiments described in the disclosure and/or the technical features in the embodiments may be combined with the prior art in any manner on the premise of no conflict, and the combined technical solution should also fall within the scope of protection of the disclosure.

It should be understood that in various method embodiments of the disclosure, the size of the sequence number of the above-mentioned processes does not mean the order of execution, and the execution order of each process is determined by its function and inherent logic, and should not constitute any limitation on the implementation process of the embodiments of the disclosure. Further, in embodiments of the disclosure, the terms “downlink”, “uplink” and “sidelink” are used for representing transmission directions of signals or data. The term “downlink” is used for representing that the transmission direction of signals or data is a first direction from a site to a UE in a cell, the term “uplink” is used for representing that the transmission direction of signals or data is a second direction from the UE in the cell to the site, and the term “sidelink” is used for representing that the transmission direction of signals or data is a third direction from a first UE to a second UE. For example, the “downlink signal” means that the transmission direction of the signal is the first direction. In addition, in the embodiments of the disclosure, the term “and/or” is only an association relationship for describing the associated objects, and represents that three relationships may exist Specifically, A and/or B may represent the following three cases: A exists separately, both A and B exist, and B exists separately. In addition, the character “/” in this specification generally indicates an “or” relationship between the associated objects.

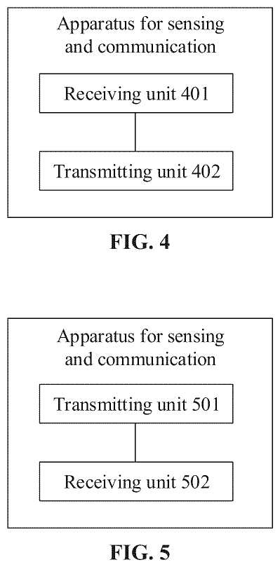

FIG. 4 is a first schematic diagram of structure composition of an apparatus for sensing and communication provided in an embodiment of the disclosure. The apparatus is applied to a first node, and as illustrated in FIG. 4, the apparatus for sensing and communication includes a receiving unit 401.

The receiving unit 401 is configured to receive first information from a second node. The first information includes at least one of: information of the second node, information of a sensed object, constraint information of a sensing node, constraint information of a sensing signal, constraint information of a sensing signal transmission resource, or information of a sensing service.

In some implementations, the second node is a node for initiating the sensing service; or, the second node is a node for transmitting a sensing service request.

In some implementations, the information of the second node includes at least one of: a type of the second node, battery level information of the second node, position information of the second node, radio resource occupancy information of the second node, sensing capability information of the second node, or measurement capability information of the second node.

In some implementations, the sensing capability information of the second node includes at least one of: first indication information for indicating whether the second node is able to serve as a sender of a sensing signal and/or a receiver of the sensing signal, second indication information for indicating a sensing signal characteristic quantity supported by the second node, or third indication information for indicating a sensing signal transmission resource supported by the second node.

In some implementations, the measurement capability information of the second node includes at least one of: fourth indication information for indicating whether the second node is able to serve as a sender of a measurement signal and/or a receiver of the measurement signal, fifth indication information for indicating a measurement signal characteristic quantity supported by the second node, sixth indication information for indicating a measurement accuracy supported by the second node, or seventh indication information for indicating a measurement signal transmission resource supported by the second node.

In some implementations, the receiving unit 401 is configured to receive a measurement result corresponding to the measurement signal. The measurement result is used for the first node to configure at least one of: a sensing node, a sensing signal, or a sensing signal transmission resource.

In some implementations, the information of the sensed object includes at least one of: a relative position relationship between the sensed object and the second node, an appearance characteristic of the sensed object, or a movement characteristic of the sensed object.

In some implementations, the relative position relationship between the sensed object and the second node includes at least one of: at least one of a position, a distance, an angle, or a height of the sensed object relative to the second node, or a wearing state of the second node by the sensed object.

In some implementations, the appearance characteristic of the sensed object is used for determining at least one of: a type of the sensed object, or a size of the sensed object.

In some implementations, the movement characteristic of the sensed object includes at least one of: a movement mode of the sensed object, a movement speed of the sensed object, a movement direction of the sensed object, or a movement range of the sensed object.

In some implementations, the constraint information of the sensing node includes at least one of: node information allowed to participate in sensing or node information restricted from participating in sensing.

In some implementations, the node information allowed to participate in sensing includes at least one node type allowed to participate in sensing and/or at least one node identifier allowed to participate in sensing. The node information restricted from participating in sensing includes at least one node type restricted from participating in sensing and/or at least one node identifier restricted from participating in sensing.

In some implementations, the constraint information of the sensing signal includes at least one of: signal information allowed to participate in sensing or signal information restricted from participating in sensing.

In some implementations, the signal information allowed to participate in sensing includes at least one signal type allowed to participate in sensing and/or at least one signal characteristic allowed to participate in sensing. The signal information restricted from participating in sensing includes at least one signal type restricted from participating in sensing and/or at least one signal characteristic restricted from participating in sensing.

In some implementations, the constraint information of the sensing signal transmission resource includes at least one of: a transmission resource allowed to participate in sensing or a transmission resource restricted from participating in sensing.

In some implementations, the information of the sensing service includes at least one of: a type of the sensing service, a sensing characteristic corresponding to the sensing service, a sensing time range corresponding to the sensing service, a triggering condition of the sensing service, an interruption condition of the sensing service, or a restart condition of the sensing service.

In some implementations, the sensing characteristic corresponding to the sensing service includes at least one of: a sensing signal characteristic quantity corresponding to the sensing service, a detection accuracy corresponding to the sensing service, or a sensing latency corresponding to the sensing service.

In some implementations, the sensing time range corresponding to the sensing service is represented by at least two of: a starting time corresponding to the sensing service, an ending time corresponding to the sensing service, or a duration corresponding to the sensing service.

In some implementations, the sensing time range corresponding to the sensing service is represented by at least one of: an ending time corresponding to the sensing service, or a duration corresponding to the sensing service, herein, a starting time corresponding to the sensing service is a predefined reference time.

In some implementations, the reference time is a time at which the first node receives the first information from the second node.

In some implementations, the triggering condition of the sensing service includes: a sensing node obtaining a trigger signaling for triggering the sensing service.

In some implementations, the trigger signaling is a physical layer signaling or a higher layer signaling.

In some implementations, the interruption condition of the sensing service includes at least one of: a sensed object and/or a sensing node generate a communication service other than the sensing service, a movement state of the sensed object changes, a position of the sensed object changes, the position of the sensed object is not in a target range, or consecutive multiple times of sensing failures occur for the sensing service.

In some implementations, the restart condition of the sensing service includes: ending of a communication service, other than the sensing service, of a sensed object and/or a sensing node.

As an example, the sensing signal characteristic quantity includes at least one of: an RSSI of the sensing signal, an RSRP of the sensing signal, a CQI of the sensing signal, an angle of arrival of the sensing signal, beam information of the sensing signal, a line-of-sight path of the sensing signal, a multipath delay of the sensing signal, a Doppler shift of the sensing signal, a phase of the sensing signal, complete channel information of the sensing signal, or quantized channel information of the sensing signal.

In some implementations, the apparatus further includes a transmitting unit 402 configured to transmit second information to the second node. The second information is used for requesting the second node to report the first information to the first node.

In some implementations, the second information is further used for indicating information type(s) in the first information reported by the second node.

In some implementation, the transmitting unit 402 is configured to transmit third information for configuring at least one of: a sensing node, sensing signal-related information, a measurement node, or measurement signal-related information.

It should be understood by a person of ordinary skill in the art that the relevant description of the above apparatus for sensing and communication in the embodiments of the disclosure may be understood with reference to relevant description of the method for sensing and communication in the embodiments of the disclosure.

FIG. 5 is a second schematic diagram of structure composition of an apparatus for sensing and communication provided in an embodiment of the disclosure. The apparatus is applied to a second node, and as illustrated in FIG. 5, the apparatus for sensing and communication includes a transmitting unit 501.

The transmitting unit 501 is configured to transmit first information to a first node. The first information includes at least one of: information of the second node, information of a sensed object, constraint information of a sensing node, constraint information of a sensing signal, constraint information of a sensing signal transmission resource, or information of a sensing service.

In some implementations, the second node is a node for initiating the sensing service; or, the second node is a node for transmitting a sensing service request.

In some implementations, the information of the second node includes at least one of: a type of the second node, battery level information of the second node, position information of the second node, radio resource occupancy information of the second node, sensing capability information of the second node, or measurement capability information of the second node.

In some implementations, the sensing capability information of the second node includes at least one of: first indication information for indicating whether the second node is able to serve as a sender of a sensing signal and/or a receiver of the sensing signal, second indication information for indicating a sensing signal characteristic quantity supported by the second node, or third indication information for indicating a sensing signal transmission resource supported by the second node.

In some implementations, the measurement capability information of the second node includes at least one of: fourth indication information for indicating whether the second node is able to serve as a sender of a measurement signal and/or a receiver of the measurement signal, fifth indication information for indicating a measurement signal characteristic quantity supported by the second node, sixth indication information for indicating a measurement accuracy supported by the second node, or seventh indication information for indicating a measurement signal transmission resource supported by the second node.

In some implementations, the information of the sensed object includes at least one of: a relative position relationship between the sensed object and the second node, an appearance characteristic of the sensed object, or a movement characteristic of the sensed object.

In some implementations, the relative position relationship between the sensed object and the second node includes at least one of: at least one of a position, a distance, an angle, or a height of the sensed object relative to the second node, or a wearing state of the second node by the sensed object.

In some implementations, the appearance characteristic of the sensed object is used for determining at least one of: a type of the sensed object, or a size of the sensed object.

In some implementations, the movement characteristic of the sensed object includes at least one of: a movement mode of the sensed object, a movement speed of the sensed object, a movement direction of the sensed object, or a movement range of the sensed object.

In some implementations, the constraint information of the sensing node includes at least one of: node information allowed to participate in sensing or node information restricted from participating in sensing.

In some implementations, the node information allowed to participate in sensing includes at least one node type allowed to participate in sensing and/or at least one node identifier allowed to participate in sensing. The node information restricted from participating in sensing includes at least one node type restricted from participating in sensing and/or at least one node identifier restricted from participating in sensing.

In some implementations, the constraint information of the sensing signal includes at least one of: signal information allowed to participate in sensing or signal information restricted from participating in sensing.

In some implementations, the signal information allowed to participate in sensing includes at least one signal type allowed to participate in sensing and/or at least one signal characteristic allowed to participate in sensing. The signal information restricted from participating in sensing includes at least one signal type restricted from participating in sensing and/or at least one signal characteristic restricted from participating in sensing.

In some implementations, the constraint information of the sensing signal transmission resource includes at least one of: a transmission resource allowed to participate in sensing or a transmission resource restricted from participating in sensing.

In some implementations, the information of the sensing service includes at least one of: a type of the sensing service, a sensing characteristic corresponding to the sensing service, a sensing time range corresponding to the sensing service, a triggering condition of the sensing service, an interruption condition of the sensing service, or a restart condition of the sensing service.

In some implementations, the sensing characteristic corresponding to the sensing service includes at least one of: a sensing signal characteristic quantity corresponding to the sensing service, a detection accuracy corresponding to the sensing service, or a sensing latency corresponding to the sensing service.

In some implementations, the sensing time range corresponding to the sensing service is represented by at least two of: a starting time corresponding to the sensing service, an ending time corresponding to the sensing service, or a duration corresponding to the sensing service.

In some implementations, the sensing time range corresponding to the sensing service is represented by at least one of: an ending time corresponding to the sensing service, or a duration corresponding to the sensing service. Herein, a starting time corresponding to the sensing service is a predefined reference time.

In some implementations, the reference time is a time at which the first node receives the first information from the second node.

In some implementations, the triggering condition of the sensing service includes: a sensing node obtaining a trigger signaling for triggering the sensing service.

In some implementations, the trigger signaling is a physical layer signaling or a higher layer signaling.

In some implementations, the interruption condition of the sensing service includes at least one of: a sensed object and/or a sensing node generate a communication service other than the sensing service, a movement state of the sensed object changes, a position of the sensed object changes, the position of the sensed object is not in a target range, or consecutive multiple times of sensing failures occur for the sensing service.

In some implementations, the restart condition of the sensing service includes: ending of a communication service, other than the sensing service, of a sensed object and/or a sensing node.

As an example, the sensing signal characteristic quantity includes at least one of: an RSSI of the sensing signal, an RSRP of the sensing signal, a CQI of the sensing signal, an angle of arrival of the sensing signal, beam information of the sensing signal, a line-of-sight path of the sensing signal, a multipath delay of the sensing signal, a Doppler shift of the sensing signal, a phase of the sensing signal, complete channel information of the sensing signal, or quantized channel information of the sensing signal.

In some implementations, the apparatus further includes a receiving unit 502 configured to receive second information from the first node. The second information is used for requesting the second node to report the first information to the first node.

In some implementations, the second information is further used for indicating information type(s) in the first information reported by the second node.

It should be understood by a person of ordinary skill in the art that the relevant description of the above apparatus for sensing and communication in the embodiments of the disclosure may be understood with reference to relevant description of the method for sensing and communication in the embodiments of the disclosure.

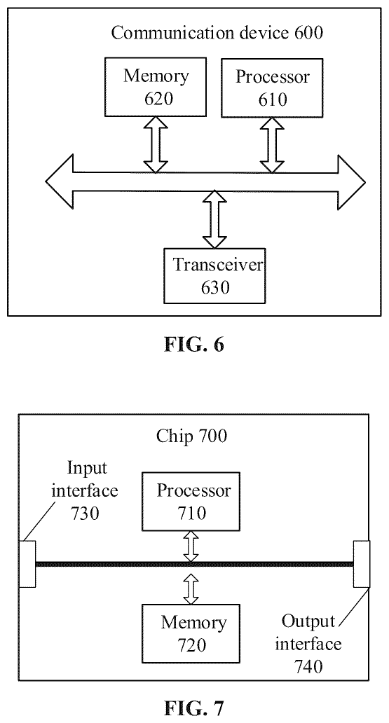

FIG. 6 is a schematic structural diagram of a communication device 600 according to an embodiment of the disclosure. The communication device may be a first node or a second node. The communication device 600 illustrated in FIG. 6 includes a processor 610. The processor 610 may be configured to call a computer program stored in a memory and run the computer program to perform the method according to the embodiments of the disclosure.

Optionally, as illustrated in FIG. 6, the communication device 600 may further include a memory 620. The processor 610 may be configured to call the computer program stored in the memory 620 and run the computer program to perform the method according to the embodiments of the disclosure.

The memory 620 may be a separate device independent from the processor 610, or may be integrated in the processor 610.

Optionally, as illustrated in FIG. 6, the communication device 600 may further include a transceiver 630. The processor 610 may control the transceiver 630 to communicate with other devices, specifically, to transmit information or data to other devices, or receive information or data from other devices.

The transceiver 630 may include a transmitter and a receiver. The transceiver 630 may further include an antenna, and there may be one or more antennas.

Optionally, the communication device 600 may specifically be the first node in embodiments of the disclosure. The communication device 600 may perform corresponding processes that are implemented by the first node in various methods of the embodiments of the disclosure. For brevity, details will not be elaborated herein again.

Optionally, the communication device 600 may specifically be the second node in embodiments of the disclosure. The communication device 600 may perform corresponding processes that are implemented by the second node in various methods of the embodiments of the disclosure. For brevity, details will not be elaborated herein again.

FIG. 7 is a schematic structural diagram of a chip according to an embodiment of the disclosure. The chip 700 illustrated in FIG. 7 includes a processor 710. The processor 710 may be configured to call a computer program stored in a memory and run the computer program to perform the method according to the embodiments of the disclosure.

Optionally, as illustrated in FIG. 7, the chip 700 may further include a memory 720. The processor 710 may be configured to call the computer program stored in the memory 720 and run the computer program to perform the method according to the embodiments of the disclosure.

The memory 720 may be a separate device independent from the processor 710, or may be integrated in the processor 710.

Optionally, the chip 700 may further include an input interface 730. The processor 710 may control the input interface 730 to communicate with other devices or chips, specifically, to obtain information or data from other devices or chips.

Optionally, the chip 700 may further include an output interface 740. The processor 710 may control the output interface 740 to communicate with other devices or chips, specifically, to output information or data to other devices or chips.

Optionally, the chip may be applied to a first node in embodiments of the disclosure. The chip may perform corresponding processes that are performed by the first node in various methods of the embodiments of the disclosure. For brevity, details will not be elaborated herein again.

Optionally, the chip may be applied to a second node in embodiments of the disclosure. The chip may perform corresponding processes that are performed by the second node in various methods of the embodiments of the disclosure. For brevity, details will not be elaborated herein again.

It should be understood that, the chip mentioned in the embodiments of the disclosure may be also referred to as a system-level chip, a system chip, a chip system or a chip of a system-on-chip, or the like.

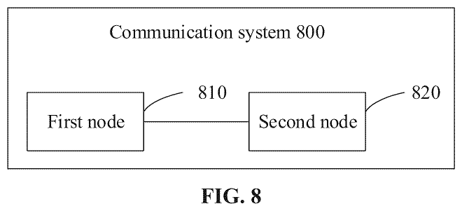

FIG. 8 is a schematic block diagram of a communication system 800 provided in an embodiment of the disclosure. As illustrated in FIG. 8, the communication system 800 includes a first node 810 and a second node 820.

The first node 810 may be configured to perform corresponding functions that are performed by the first node in the above methods. The second node 820 may be configured to perform corresponding functions that are performed by the second node in the above methods. For brevity, details will not be elaborated herein again.

It should be understood that the processor in the embodiments of the disclosure may be an integrated circuit chip having a signal processing capability. During implementation, the operations of the foregoing method embodiments may be implemented by using a hardware integrated logic circuit in the processor or implemented by using instructions in a software form. The foregoing processor may be a general purpose processor, a digital signal processor (DSP), an application-specific integrated circuit (ASIC), a field programmable gate array (FPGA) or another programmable logical device, discrete gate or transistor logical device, or discrete hardware component. The processor may implement or perform methods, operations and logical block diagrams disclosed in the embodiments of the disclosure. The general purpose processor may be a microprocessor or the processor may be any conventional processor and the like. Operations of the methods disclosed with reference to the embodiments of the disclosure may be directly executed and completed by means of a hardware decoding processor, or may be executed and completed by using a combination of hardware and software modules in the decoding processor. The software module may be located in a mature storage medium in the field, such as a random access memory (RAM), a flash memory, a read-only memory (ROM), a programmable ROM (PROM), an electrically-erasable programmable memory, or a register. The storage medium is located in the memory, and the processor reads information in the memory and completes the operations in the foregoing methods in combination with hardware of the processor.

It can be understood that the memory in the embodiments of the disclosure may be a volatile memory or a non-volatile memory, or may include both a volatile memory and a non-volatile memory. The non-volatile memory may be an ROM, a PROM, an erasable PROM (EPROM), an electrically EPROM (EEPROM) or a flash memory. The volatile memory may be an RAM and is used as an external cache. Through exemplary but not limited description, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM) and a direct rambus RAM (DR RAM). It should be noted that the memory of the system and the method described herein aims to include but not be limited to these memories and any other suitable types of memories.

It should be understood that the foregoing memory is exemplary but not limited description, for example, the memory in the embodiments of the disclosure may be an SRAM, a DRAM, an SDRAM, a DDR SDRAM, an ESDRAM, an SLDRA and a DR RAM, and the like. It should be noted that the memory in the embodiments of the disclosure aims to include but not be limited to these memories and any other suitable types of memories.

An embodiment of the disclosure further provides a computer-readable storage medium configured to store a computer program.

Optionally, the computer-readable storage medium may be applied to the first node in embodiments of the disclosure, and the computer program causes a computer to perform corresponding processes that are performed by the first node in various methods of the embodiments of the disclosure. For brevity, details will not be elaborated herein again.

Optionally, the computer-readable storage medium may be applied to the second node in embodiments of the disclosure, and the computer program causes a computer to perform corresponding processes that are performed by the second node in various methods of the embodiments of the disclosure. For brevity, details will not be elaborated herein again.

An embodiment of the disclosure further provides a computer program product including computer program instructions.

Optionally, the computer program product may be applied to the first node in embodiments of the disclosure, and the computer program instructions cause a computer to perform corresponding processes that are performed by the first node in various methods of the embodiments of the disclosure. For brevity, details will not be elaborated herein again.

Optionally, the computer program product may be applied to the second node in embodiments of the disclosure, and the computer program instructions cause a computer to perform corresponding processes that are performed by the second node in various methods of the embodiments of the disclosure. For brevity, details will not be elaborated herein again.

An embodiment of the disclosure further provides a computer program.

Optionally, the computer program may be applied to the first node in embodiments of the disclosure, and the computer program, when being run on a computer, causes the computer to perform corresponding processes that are performed by the first node in various methods of the embodiments of the disclosure. For brevity, details will not be elaborated herein again.

Optionally, the computer program may be applied to the second node in embodiments of the disclosure, and the computer program, when being run on a computer, causes the computer to perform corresponding processes that are performed by the second node in various methods of the embodiments of the disclosure. For brevity, details will not be elaborated herein again.

A person of ordinary skill in the art may be aware that exemplary units and algorithm operations described in combination with the embodiments disclosed in this specification may be implemented by electronic hardware, or a combination of computer software and electronic hardware. Whether the functions are performed by hardware or software depends on particular applications and design constraint conditions of the technical solutions. Those skilled in the art may use different methods to implement the described functions for each particular application, but it should not be considered that the implementation goes beyond the scope of the disclosure.

It may be clearly understood by those skilled in the art that for the purpose of convenient and brief description, the references may be made to the corresponding processes in the foregoing method embodiments for the detailed working process of the foregoing system, apparatus, and units, and details are not described herein again.

In the several embodiments provided in the disclosure, it should be understood that the disclosed system, apparatus, device, and method may be implemented in other manners. For example, the described apparatus embodiments are merely exemplary. For example, the unit division is merely a logical function division and there may be other divisions in actual implementation. For example, multiple units or components may be combined or integrated into another system, or some features may be ignored or not performed. In addition, the displayed or discussed mutual couplings or direct couplings or communication connections may be the indirect couplings or communication connections through some interfaces, apparatuses or units, which may be in electrical, mechanical or other forms.

The units described as separate parts may be or may not be physically separate, and parts displayed as units may be or may not be physical units, they may be located in one position, or may be distributed on multiple network units. Some or all of the units may be selected according to actual needs to achieve the objectives of the solutions of the embodiments.

In addition, functional units in the embodiments of this disclosure may be integrated into one processing unit, or each of the units may exist alone physically, or two or more units are integrated into one unit.

When the functions are implemented in form of a software functional module and sold or used as an independent product, the functions may be stored in a computer-readable storage medium. Based on such an understanding, the technical solutions of the disclosure essentially, or the part contributing to the prior art, or part of the technical solutions may be implemented in the form of a software product. The computer software product is stored in a storage medium, and includes several instructions for instructing a computer device (which may be a personal computer, a server, a network device, or the like) to perform all or part of the operations of the methods described in the embodiments of the disclosure. The foregoing storage medium includes any medium that can store program codes, such as a USB flash disk, a removable hard disk, an ROM, an RAM, a magnetic disk, or an optical disk.

The foregoing descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure shall be subject to the scope of protection of the claims.

1. A method for sensing and communication, comprising:
receiving, by a first node, first information from a second node, the first information comprising at least one of: information of the second node, information of a sensed object, constraint information of a sensing node, constraint information of a sensing signal, constraint information of a sensing signal transmission resource, or information of a sensing service.

2. The method of claim 1, wherein
the second node is a node for initiating the sensing service; or,
the second node is a node for transmitting a sensing service request.

3. The method of claim 1, wherein the information of the second node comprises at least one of: a type of the second node, battery level information of the second node, position information of the second node, radio resource occupancy information of the second node, sensing capability information of the second node, or measurement capability information of the second node.

4. The method of claim 1, wherein the information of the sensed object comprises at least one of: a relative position relationship between the sensed object and the second node, an appearance characteristic of the sensed object, or a movement characteristic of the sensed object.

5. The method of claim 1, wherein the constraint information of the sensing node comprises at least one of: node information allowed to participate in sensing or node information restricted from participating in sensing.

6. The method of claim 1, wherein the constraint information of the sensing signal comprises at least one of: signal information allowed to participate in sensing or signal information restricted from participating in sensing.

7. The method of claim 1, wherein the constraint information of the sensing signal transmission resource comprises at least one of: a transmission resource allowed to participate in sensing or a transmission resource restricted from participating in sensing.

8. The method of claim 1, wherein the information of the sensing service comprises at least one of: a type of the sensing service, a sensing characteristic corresponding to the sensing service, a sensing time range corresponding to the sensing service, a triggering condition of the sensing service, an interruption condition of the sensing service, or a restart condition of the sensing service.

9. An apparatus for sensing and communication, applied to a first node, the apparatus comprising:
a transceiver;
a processor; and
a memory for storing a computer program that, when executed by the processor, causes the processor to receive, through the transceiver, first information from a second node, the first information comprising at least one of: information of the second node, information of a sensed object, constraint information of a sensing node, constraint information of a sensing signal, constraint information of a sensing signal transmission resource, or information of a sensing service.

10. The apparatus of claim 9, wherein the information of the second node comprises at least one of: a type of the second node, battery level information of the second node, position information of the second node, radio resource occupancy information of the second node, sensing capability information of the second node, or measurement capability information of the second node.

11. The apparatus of claim 10, wherein the sensing capability information of the second node comprises at least one of:
first indication information for indicating whether the second node is able to serve as a sender of a sensing signal and/or a receiver of the sensing signal;
second indication information for indicating a sensing signal characteristic quantity supported by the second node; or
third indication information for indicating a sensing signal transmission resource supported by the second node.

12. The apparatus of claim 10, wherein the measurement capability information of the second node comprises at least one of:
fourth indication information for indicating whether the second node is able to serve as a sender of a measurement signal and/or a receiver of the measurement signal;
fifth indication information for indicating a measurement signal characteristic quantity supported by the second node;
sixth indication information for indicating a measurement accuracy supported by the second node; or
seventh indication information for indicating a measurement signal transmission resource supported by the second node,
wherein the method further comprises:
receiving, by the first node, a measurement result corresponding to the measurement signal, wherein the measurement result is used by the first node to configure at least one of: a sensing node, a sensing signal, or a sensing signal transmission resource.

13. The apparatus of claim 9, wherein the information of the sensed object comprises at least one of: a relative position relationship between the sensed object and the second node, an appearance characteristic of the sensed object, or a movement characteristic of the sensed object.

14. The apparatus of claim 13, wherein at least one of the following applies:
the relative position relationship between the sensed object and the second node comprises at least one of: at least one of a position, a distance, an angle, or a height of the sensed object relative to the second node; or a wearing state of the second node by the sensed object;
the appearance characteristic of the sensed object is used for determining at least one of: a type of the sensed object, or a size of the sensed object; or
the movement characteristic of the sensed object comprises at least one of: a movement mode of the sensed object, a movement speed of the sensed object, a movement direction of the sensed object, or a movement range of the sensed object.

15. The apparatus of claim 9, wherein the information of the sensing service comprises at least one of: a type of the sensing service, a sensing characteristic corresponding to the sensing service, a sensing time range corresponding to the sensing service, a triggering condition of the sensing service, an interruption condition of the sensing service, or a restart condition of the sensing service.

16. The apparatus of claim 15, wherein at least one of the following applies:
the sensing characteristic corresponding to the sensing service comprises at least one of: a sensing signal characteristic quantity corresponding to the sensing service, a detection accuracy corresponding to the sensing service, or a sensing latency corresponding to the sensing service;
the sensing time range corresponding to the sensing service is represented by at least two of: a starting time corresponding to the sensing service, an ending time corresponding to the sensing service, or a duration corresponding to the sensing service;
the sensing time range corresponding to the sensing service is represented by at least one of: an ending time corresponding to the sensing service, or a duration corresponding to the sensing service, wherein a starting time corresponding to the sensing service is a predefined reference time, and the reference time is a time at which the first node receives the first information from the second node;
the triggering condition of the sensing service comprises: a sensing node obtaining a trigger signaling for triggering the sensing service, wherein the trigger signaling is a physical layer signaling or a higher layer signaling;
the interruption condition of the sensing service comprises at least one of: a sensed object and/or a sensing node generating a communication service other than the sensing service; a movement state of the sensed object changing; a position of the sensed object changing; the position of the sensed object being not in a target range; or consecutive multiple times of sensing failures occurring for the sensing service; or
the restart condition of the sensing service comprises: ending of a communication service, other than the sensing service, of a sensed object and/or a sensing node.

17. An apparatus for sensing and communication, applied to a second node, the apparatus comprising:
a transceiver;
a processor; and
a memory for storing a computer program that, when executed by the processor, causes the processor to transmit, through the transceiver, first information to a first node, the first information comprising at least one of: information of the second node, information of a sensed object, constraint information of a sensing node, constraint information of a sensing signal, constraint information of a sensing signal transmission resource, or information of a sensing service.

18. The apparatus of claim 17, wherein the constraint information of the sensing node comprises at least one of: node information allowed to participate in sensing or node information restricted from participating in sensing.

19. The apparatus of claim 18, wherein
the node information allowed to participate in sensing comprises at least one node type allowed to participate in sensing and/or at least one node identifier allowed to participate in sensing; and
the node information restricted from participating in sensing comprises at least one node type restricted from participating in sensing and/or at least one node identifier restricted from participating in sensing.

20. The apparatus of claim 17, wherein the processor is configured to: before transmitting the first information to the first node,
receive, through the transceiver, second information from the first node, wherein the second information is used for requesting the second node to report the first information to the first node and indicates information type(s) in the first information reported by the second node.
